(19) United States
(12) Patent Application Publication
(10) Pub. No.: US 2026/0138013 A1
(43) Pub. Date: May 21, 2026

(54) SCORING METHOD AND APPARATUS BASED ON VIRTUAL MATCH, DEVICE, MEDIUM, AND PROGRAM PRODUCT

(71) Applicant: Tencent Technology (Shenzhen) Company Limited, Shenzhen (CN)

(72) Inventors: Weisong ZHANG, Shenzhen (CN); Yuan MING, Shenzhen (CN)

(21) Appl. No.: 19/447,847

(22) Filed: Jan. 13, 2026

Related U.S. Application Data
(63) Continuation of application No. PCT/CN2024/113729, filed on Aug. 21, 2024.

(30) Foreign Application Priority Data
Oct. 24, 2023 (CN) 202311388886.7

(51) Int. Cl. A63F 13/46

(52) U.S. Cl. CPC A63F 13/46

(57) ABSTRACT

A method for scoring a virtual match is performed by a computer device. The method includes: obtaining first character data of a first virtual character after a first account controls the virtual character to participate in a virtual match; obtaining tier rank data of the first account, the tier rank data representing a level of the first account after participating in the virtual match; determining sorting data of the first character data in comprehensive character data; obtaining win rate data that is generated when the virtual character corresponding to the first account participates in the virtual match (503); generating character comprehensive scoring data based on the sorting data and the win rate data; and displaying the character comprehensive scoring data on an interface of the computer device associated with the first account.

### CROSS-REFERENCE TO RELATED APPLICATIONS

This application is a continuation application of PCT Patent Application No. PCT/CN2024/113729, entitled “SCORING METHOD AND APPARATUS BASED ON VIRTUAL MATCH, DEVICE, MEDIUM, AND PROGRAM PRODUCT” filed on Aug. 21, 2024, which claims priority to Chinese Patent Application No. 202311388886.7, entitled “SCORING METHOD AND APPARATUS BASED ON VIRTUAL MATCH, DEVICE, MEDIUM, AND PROGRAM PRODUCT” filed on Oct. 24, 2023, all of which are incorporated by reference in their entirety.

### FIELD OF THE TECHNOLOGY

Embodiments of this application relate to the field of data processing, and in particular, to a scoring method and apparatus based on a virtual match, a device, a medium, and a program product.

### BACKGROUND OF THE DISCLOSURE

In an application program including a virtual scene, a user can usually control a virtual object to move or interact with another virtual object in the virtual scene. For example, in a game, a player can control a virtual object to engage in a virtual battle with a non-player character (NPC) or another virtual object in a virtual scene.

In the related art, for a plurality of matches in which a player participates, a data radar chart may be displayed on a data presentation interface. Different nodes (indicated by axes radiating from the center to the outside) of the radar chart correspond to performance of the player in different aspects, such as a team fight participation status, an output status, and a kill count.

However, information presented in the radar chart is limited, usually only a few key indicators can be generically reflected, evaluation on a player is relatively one-sided, and accuracy of evaluation on match performance of a player is relatively low.

### SUMMARY

Embodiments of this application provide a scoring method and apparatus based on a virtual match, a device, a medium, and a program product, to improve accuracy of evaluation on match performance of a player. The technical solutions are as follows.

According to an aspect, a method for scoring a virtual match is performed by a computer device. The method includes:
obtaining first character data of a first virtual character after a first account controls the virtual character to participate in a virtual match;
obtaining tier rank data of the first account, the tier rank data representing a level of the first account after participating in the virtual match;
determining sorting data of the first character data in comprehensive character data, the comprehensive character data comprising a plurality of pieces of second character data of a second virtual character after a reference account controls the second virtual character to participate in a virtual match;
obtaining win rate data of the first account that controls the first virtual character to participate in the virtual match;
generating character comprehensive scoring data based on the sorting data and the win rate data; and
displaying the character comprehensive scoring data on an interface of the computer device associated with the first account.

According to another aspect, a computer device is provided. The computer device includes a processor and a memory, the memory having at least one instruction, at least one program, a code set or an instruction set stored therein, the at least one instruction, the at least one program, the code set, or the instruction set, when executed by the processor, causing the computer device to implement the scoring method based on a virtual match according to any one of the foregoing aspects.

According to another aspect, a non-transitory computer-readable storage medium is provided. The storage medium has at least one instruction, at least one program, a code set or an instruction set stored therein, the at least one instruction, the at least one program, the code set, or the instruction set, when executed by a processor of a computer device, causing the computer device to implement the scoring method based on a virtual match according to any one of the foregoing aspects.

The technical solutions provided in the embodiments of this application have at least the following beneficial effects.

When match performance of the player is scored, the comprehensive score of the player is determined based on the win rate data of the player to participate in the virtual match and a ranking relationship between the match data that is generated when the player participates in the virtual match and other players. On the one hand, the match performance of the player is comprehensively evaluated based on the comprehensive score. The comprehensive score can not only reflect a win rate of the player, but also reflect specific performance data of the player in the match, thereby improving comprehensiveness of evaluation on the match performance of the player. On the other hand, the ranking relationship between the match data that is generated when the player participates in the virtual match and other players is introduced, so that the comprehensive score can reflect a match level of the player compared with an entire player group, thereby improving accuracy of evaluation on the match performance of the player.

### BRIEF DESCRIPTION OF THE DRAWINGS

FIG. 1 is a schematic diagram of a score based on a virtual match according to an exemplary embodiment of this application;

FIG. 2 is a schematic diagram of a score based on a virtual match according to another exemplary embodiment of this application;

FIG. 3 is a block diagram of a structure of an electronic device according to an exemplary embodiment of this application;

FIG. 4 is a schematic diagram of a computer system according to an exemplary embodiment of this application;

FIG. 5 is a flowchart of a scoring method based on a virtual match according to an exemplary embodiment of this application;

FIG. 6 is a flowchart of a scoring method based on a virtual match according to another exemplary embodiment of this application;

FIG. 7 is a schematic diagram of a process of obtaining sorting data corresponding to first character data according to an embodiment shown in FIG. 6;

FIG. 8 is a flowchart of a scoring method based on a virtual match according to another exemplary embodiment of this application;

FIG. 9 is a flowchart of a score display method based on a virtual match according to an exemplary embodiment of this application;

FIG. 10 is a schematic diagram of an overall flow of a scoring method based on a virtual match according to an exemplary embodiment of this application;

FIG. 11 is a block diagram of a structure of a scoring apparatus based on a virtual match according to an exemplary embodiment of this application;

FIG. 12 is a block diagram of a structure of a scoring apparatus based on a virtual match according to another exemplary embodiment of this application;

FIG. 13 is a block diagram of a structure of a scoring apparatus based on a virtual match according to another exemplary embodiment of this application; and

FIG. 14 is a block diagram of a structure of a computer device according to an exemplary embodiment of this application.

### DESCRIPTION OF EMBODIMENTS

In a game application program or some application programs based on virtual scenes, a player can usually control a virtual object to perform various actions in the virtual scene, or the player can control the virtual object to interact with another virtual object in the virtual scene. For example, a player can control a main control virtual object to perform dancing interaction and virtual attack interaction with a main control virtual object of another player in a virtual scene; and the main control virtual object may alternatively be controlled to interact with an NPC in a virtual scene.

In some embodiments, the player controls the virtual object to participate in a virtual match in the application program, and generates a match result and match data. The match result and the match data can reflect a capability of the player to control the virtual object. In the related art, evaluation on the capability of the player to control the virtual object is usually reflected by using a radar chart, and different nodes of the radar chart correspond to performance of the player in different aspects, such as a team fight participation status, an output status, and a kill count. However, information presented in the radar chart is limited, usually only a few key indicators can be generically reflected, evaluation on a player is relatively one-sided, and accuracy of evaluation on match performance of a player is relatively low.

In the embodiments of this application, for a case in which the player controls different virtual characters to participate in the virtual match, or the player controls the virtual character to participate in the virtual match at different lane positions, overall scoring data of the player is displayed, thereby reflecting a comprehensive score of the player when the player participates in the virtual match. The overall scoring data is determined based on win rate data and data (such as resource obtaining data, attack force data, strategy data, and defeat amount data) generated in the match.

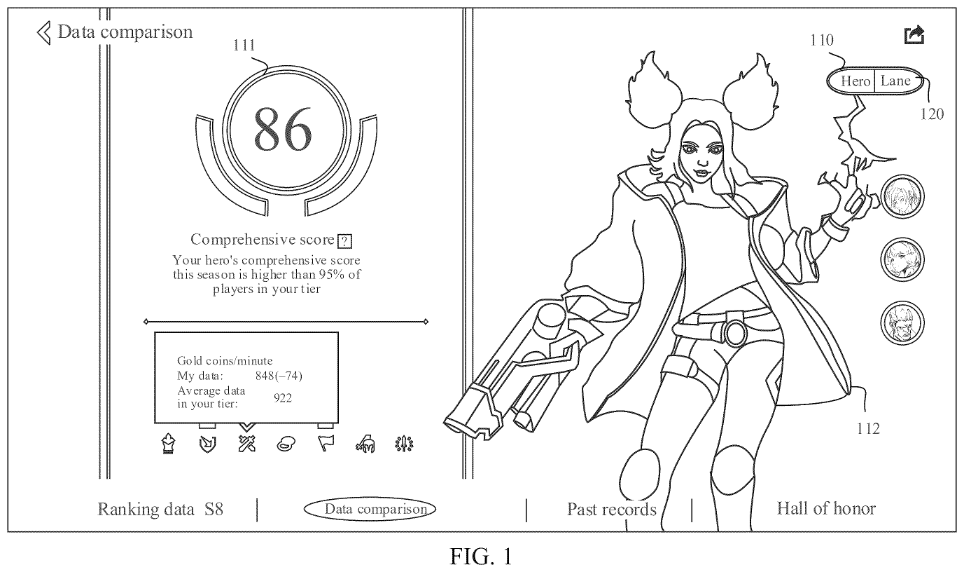

For example, referring to FIG. 1, a character option 110 and a lane option 120 are displayed on a data presentation interface. When the character option 110 is selected, as shown in FIG. 1, a comprehensive score 111 that is obtained after a player controls a specified virtual character 112 to participate in a virtual match is displayed. The specified virtual character 112 includes n virtual characters that are selected by the player to participate in the virtual match the most frequently, and n is a positive integer. The comprehensive score 111 is determined based on a win rate that is generated when the player controls the specified virtual character 112 to participate in the virtual match in a historical time period and a data ranking that is generated by controlling the specified virtual character 112 to participate in the virtual match.

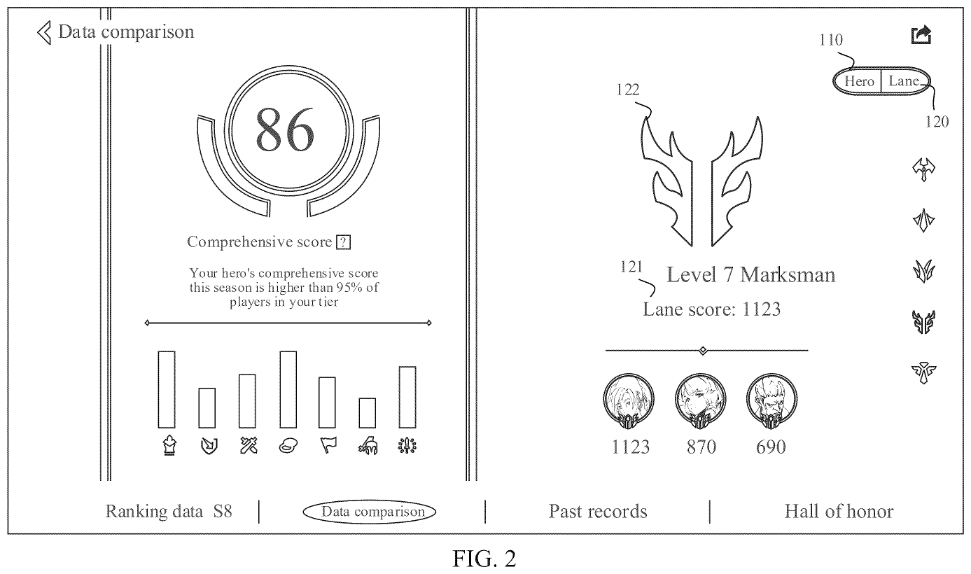

When the lane option 120 is selected, as shown in FIG. 2, a comprehensive score 121 that is obtained after the player controls the virtual character to participate in the virtual match is displayed. The comprehensive score 121 is determined based on a win rate that is generated when the player controls, in a historical time period, a specified or unspecified virtual character to participate in the virtual match at a specified lane position 122 and a data ranking that is generated by controlling the specified or unspecified virtual character to participate in the virtual match at the specified lane position 122.

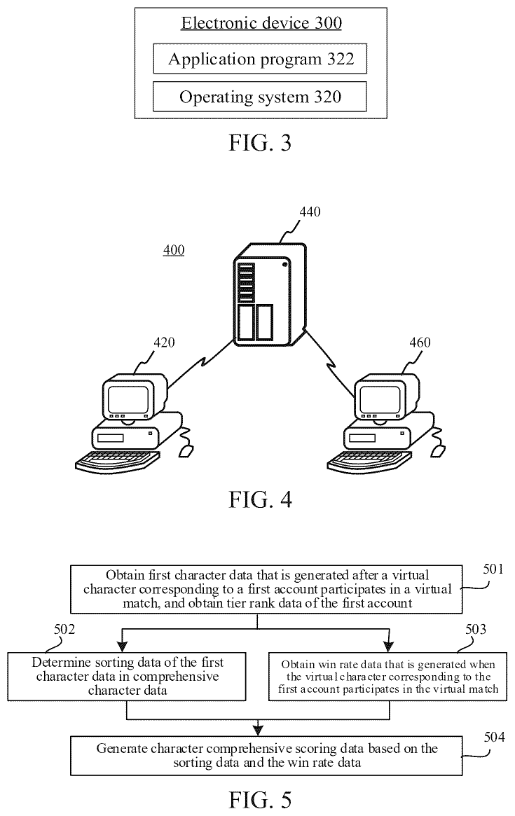

In conclusion, in the embodiments of this application, when match performance of the player is scored, the comprehensive score of the player is determined based on the win rate data of the player to participate in the virtual match and a ranking relationship between the match data that is generated when the player participates in the virtual match and other players, so that the comprehensive score is presented. The win rate and the match performance of the player are comprehensively evaluated based on the comprehensive score, thereby improving accuracy and comprehensiveness of evaluation on the match performance of the player. FIG. 3 is a block diagram of a structure of an electronic device according to an exemplary embodiment of this application. An electronic device 300 includes an operating system 320 and an application program 322. In some embodiments, the electronic device 300 may be implemented as a first device or a second device described below. The operating system 320 is basic software provided for the application program 322 to perform secure access to computer hardware. The application program 322 is an application program supporting a virtual scene.

The electronic device 300 may be implemented as a terminal. The terminal may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual scene, for example, an application program supporting a three-dimensional virtual scene, is installed and run on the terminal. The application program may be any one of a virtual reality application program, a three-dimensional map program, a third-person shooting (TPS) game, a first-person shooting (FPS) game, a multiplayer online battle arena (MOBA) game, and the like. In some embodiments, the application program may be a standalone application program, such as a standalone three-dimensional game program; or may be a network-connected application program.

FIG. 4 is a block diagram of a structure of a computer system according to an exemplary embodiment of this application. A computer system 400 includes a first device 420, a server 440, and a second device 460.

An application program supporting a virtual scene is installed and run on the first device 420. The first device 420 is a device used by a first user. The first user uses the first device 420 to control a first virtual object in the virtual scene to perform an action. The action includes, but is not limited to, at least one of body posture adjustment, crawling, walking, running, cycling, jumping, driving, picking, shooting, attacking, and throwing. For example, the first virtual object is a first virtual character such as a simulated character or a cartoon character. The first device 420 is connected to the server 440 by using a wireless network or a wired network.

The server 440 includes at least one of one server, a plurality of servers, a cloud computing platform, and a virtualization center. The server 440 is configured to provide a backend service for an application program supporting a virtual scene. In some embodiments, the server 440 undertakes main computing work, and the first device 420 and the second device 460 undertake secondary computing work. Alternatively, the server 440 undertakes secondary computing work, and the first device 420 and the second device 460 undertake main computing work. Alternatively, the server 440, the first device 420, and the second device 460 perform collaborative computing by using a distributed computing architecture.

An application program supporting a virtual scene is installed and run on the second device 460. The second device 460 is a device used by a second user. The second user uses the second device 460 to control a second virtual object in the virtual scene to perform an action. The action includes, but is not limited to, at least one of body posture adjustment, crawling, walking, running, cycling, jumping, driving, picking, shooting, attacking, and throwing. For example, the second virtual object is a second virtual character, for example, a simulated character or a cartoon character. In some embodiments, the first virtual character and the second virtual character are located in the same virtual scene. In some embodiments, the first virtual character and the second virtual character may belong to the same team or the same organization, have a friend relationship, or have a temporary communication permission. In some embodiments, the first virtual character and the second virtual character may alternatively belong to different teams, different organizations, or two groups hostile to each other.

In some embodiments, the application programs installed on the first device 420 and the second device 460 are the same, or the application programs installed on the two devices are the same type of application programs of different control system platforms. The first device 420 may generally refer to one of a plurality of devices, and the second device 460 may generally refer to one of a plurality of devices. In this embodiment, description is made by using only the first device 420 and the second device 460 as an example. Device types of the first device 420 and the second device 460 are the same or different. In some embodiments, the first device 420 and the second device 460 may be implemented as terminals.

A person skilled in the art may learn that there may be more or fewer devices. For example, there may be only one device, or there may be dozens of or hundreds of or more devices. The quantity and types of the devices are not limited in the embodiments of this application.

The server 440 may be implemented as a physical server, or may be implemented as a cloud server in a cloud. In some embodiments, the server 440 may alternatively be implemented as a node in a blockchain system.

In some embodiments, the method provided in the embodiments of this application may be applied to a cloud game scene, so that the cloud server completes computing of data logic in a game process, and a terminal is responsible for displaying a game interface.

Information (including but not limited to user equipment information, user personal information, and the like), data (including but not limited to data for analysis, data for storage, data for display, and the like), and signals involved in this application are all authorized by users or fully authorized by all parties, and collection, use, and processing of relevant data need to comply with relevant laws, regulations, and standards of relevant countries and regions. For example, game data involved in this application is acquired under full authorization.

With reference to the introduction of the terms and the description of the implementation environment, the scoring method based on a virtual match provided in the embodiments of this application is described. FIG. 5 is a flowchart of a scoring method based on a virtual match according to an exemplary embodiment of this application. The method is performed by a computer device, and an example in which the computer device is implemented as a server is used for description. As shown in FIG. 5, the method includes the following operations.

Operation 501: Obtain first character data that is generated after a virtual character corresponding to a first account participates in a virtual match, and obtain tier rank data of the first account.

In some embodiments, first character data that is generated after a computer device logged into with a first account controls a virtual character to participate in a virtual match is obtained.

The tier rank data represents a level of the first account achieved by obtaining points after participating in the virtual match.

For example, the first account is an account logged into a game application run on the terminal. The game application includes a virtual character, a player controls the terminal to use the virtual character to participate in a virtual match, and match data may be sent to the server. In some embodiments, the match data includes first character data, match points, and the like.

In some embodiments, an expression manner of the tier rank data includes at least one of the following: 1. Different tier ranks are expressed by using preset reference elements, such as Bronze, Silver, Gold, and Platinum; and 2. Different tier ranks are expressed by using preset values such as Level 1, Level 2, and Level 3. This is not limited herein. An example in which the preset reference elements are used to express different tier ranks is used. The first account may obtain some points after completing the virtual match, and when the points of the first account are within a point range of the Bronze tier, a tier of the first account is Bronze.

In some embodiments, an account participating in the virtual match has corresponding tier rank data. Alternatively, an account participating in a virtual match of a specified type has corresponding tier rank data. For example, a game includes a common match and a ranking match, and a player may obtain points when participating in the ranking match, to generate tier rank data.

The first character data is data representing a match condition of the virtual match after the virtual character corresponding to the first account participates in the virtual match. For example, the first character data includes at least one of the following data:
a character score, configured for evaluating performance of a first player to control a virtual character in a single virtual match;
a participation rate, representing a proportion that the first player controls the virtual character to participate in a virtual battle (for example, a team battle) in the virtual match;
a battle loss rate, representing a loss that is generated after the first player controls the virtual character to participate in the virtual battle in the virtual match;
resource obtaining data, referring to a resource amount of virtual resources (such as gold coins) that are obtained by the first player in the virtual match by controlling the virtual character;
damage data, referring to virtual damage that is generated to another virtual character by the first player in the virtual match by controlling the virtual character;
damage tolerance data, referring to damage that is generated when the virtual character controlled by the first player is attacked by another virtual character in the virtual match;
defense target damage data, referring to virtual damage that is generated when the virtual character controlled by the first player is attacked by a virtual scene element (such as a defense tower or a monster) in the virtual match; and
scoring data given by another player that participates in the virtual match to the first player, that is, after the virtual match is completed, a player in the same virtual match can score another player. In some embodiments, a player that is in the same virtual match and that is in a group relationship with the first player can score the first player, to represent performance of the first player in the virtual match.

The first character data is merely an example. For different virtual scenes and application programs, types and content of the first character data may be less or more. This is not limited in this embodiment of this application.

In some embodiments, the first character data that is generated after the virtual character corresponding to the first account participates in the virtual match may be obtained under a condition. For example, obtaining the first character data that is generated after a first virtual character corresponding to the first account participates in the virtual match; or obtaining the first character data that is generated after the virtual character corresponding to the first account participates in the virtual match at a first lane position; or obtaining the first character data that is generated after the first virtual character corresponding to the first account participates in the virtual match at the first lane position. The obtaining condition is not limited in this embodiment of this application.

Operation 502: Determine sorting data of the first character data in comprehensive character data.

The comprehensive character data includes a plurality of pieces of second character data, and the second character data is data that is generated when a computer device logged into with a reference account controls the virtual character to participate in the virtual match. The computer device may be implemented as a terminal device logged into with the reference account.

The comprehensive character data includes second character data that is generated after virtual characters respectively corresponding to a plurality of reference accounts participate in the virtual match, the plurality of reference accounts matches the tier rank data when the second character data is generated, and data types of the first character data and the second character data are the same.

In some embodiments, at a data preparation stage before the sorting data is obtained, pieces of second character data respectively corresponding to a plurality of candidate accounts are sorted, to obtain a data sorting result. The plurality of candidate accounts match the tier rank data when the second character data is generated.

In some embodiments, tier rank data matching includes at least one of the following cases.

First, being in the same tier rank as the first account.

To be specific, when character data is obtained, a tier rank of the candidate account is the same as a tier rank of the first account at the current moment, that is, tier ranks of the candidate accounts achieved by obtaining points after participating in the virtual match are the same.

Second, being in the same tier rank range as the first account.

To be specific, when character data is obtained, the tier rank of the candidate account is within the same tier rank range as the tier rank of the first account at the current moment. An example in which the tier rank is reflected in a numerical form is used. The tier rank is divided into three ranges, which are respectively range 1 (corresponding to tier ranks 1 to 5), range 2 (corresponding to tier ranks 6 to 10), and range 3 (corresponding to tier ranks above 11). When a current tier rank of the first account is 7, and corresponds to range 2, second character data corresponding to candidate accounts with tier ranks between 6 to 10 is obtained. In some embodiments, pieces of second character data respectively corresponding to accounts within all ranges are obtained and sorted.

Third, a tier rank with a difference from the tier rank of the first account less than a preset difference threshold.

To be specific, when character data is obtained, a difference between the tier rank of the candidate account and the tier rank of the first account at the current moment is within a preset difference range. An example in which the tier rank is reflected in a numerical form is used. When the preset difference threshold is 3, and the tier rank corresponding to the first account is 7, second character data corresponding to candidate accounts of accounts with tier ranks of 5, 6, 7, 8, and 9 is obtained. In some embodiments, pieces of second character data respectively corresponding to accounts within a preset difference range of reference value tier ranks are obtained and sorted.

The above solutions of tier rank data matching are merely examples, and the case of tier rank matching is not limited in this embodiment of this application.

Because data types of the first character data and the second character data are the same, the second character data may be obtained at the data preparation stage with reference to the foregoing obtaining manner of the first character data. For the first account and the reference account of the same tier rank, parallel comparison is performed between the first account and the reference account by using the first character data and the second character data of the same type, thereby improving accuracy and intuitiveness of comparison.

The sorting data is configured for expressing a sorting order of the first character data in the comprehensive character data.

In some embodiments, the sorting data is expressed in a form of a sorting proportion. For example, the sorting data represents a proportion that the first character data exceeds other character data in the comprehensive character data, for example, exceeds 50% of character data. That is, a sorting position of the first character data in the comprehensive character data is a middle position. Alternatively, the sorting data represents a proportion that the first character data falls below other character data in the comprehensive character data, for example, falls below 50% of character data. That is, a sorting position of the first character data in the comprehensive character data is a middle position, but the sorting position of the first character data is determined in an ascending comparison manner.

In some embodiments, to reduce a data storage amount, proportional nodes obtained after the comprehensive character data is sorted are stored, to avoid storing all the comprehensive character data, and only data of the proportional nodes needs to be stored. That is, sorting pieces of second character data respectively corresponding to a plurality of candidate accounts, to obtain a data sorting result, the plurality of candidate accounts matching the tier rank data when the second character data is generated; and determining node data from the data sorting result based on a plurality of preset proportional nodes, the node data being data at sorting positions respectively corresponding to the plurality of proportional nodes in the data sorting result.

An example in which 1% is a node change gradient is used, and node data corresponding to 100%, 99%, . . . , 2%, and 1% proportional nodes is stored. The node data of the 100% proportional nodes is largest character data in all character data, the node data of the 99% proportional nodes is character data that exceeds 99% other character data, and so on. A quantity of proportional nodes is less than a total quantity of pieces of second character data generated by the plurality of candidate accounts.

When the sorting data of the first character data in the comprehensive character data is determined, the first character data is sequentially matched with pieces of character data respectively corresponding to the plurality of proportional nodes, until a proportional node matching the first character data is determined, to determine the sorting data corresponding to the first character data. The plurality of proportional nodes are sorted in descending order, and the first character data is matched with the proportional nodes in descending order; or the plurality of proportional nodes are sorted in ascending order, and the first character data is matched with the proportional nodes in ascending order; or after the plurality of proportional nodes are sorted in descending order or in ascending order, the first character data is first matched with character data corresponding to 50% proportional nodes based on dichotomy, to determine a magnitude relationship between the first character data and the character data corresponding to the 50% proportional nodes. For example, when the first character data is greater than the character data corresponding to the 50% proportional nodes, the first character data is matched with character data corresponding to 75% proportional nodes, and so on, until the proportional node matching the first character data is determined.

In the foregoing embodiment, the pieces of second character data of the candidate accounts are sorted, and the node data matching the proportional node is determined from the data sorting result based on the proportional node. When the sorting data corresponding to the first character data is determined subsequently, the first character data is compared with the node data matching the plurality of proportional nodes, to determine the sorting data corresponding to the first character data, thereby reducing a calculation amount of data storage and comparison, and improving efficiency of determining the sorting data.

In some embodiments, a process of determining the node data corresponding to the plurality of proportional nodes is completed in advance. That is, the node data of the plurality of proportional nodes respectively corresponding to data of all tier ranks is predetermined based on a period, including node data of a plurality of proportional nodes respectively corresponding to tier ranks corresponding to the first account.

Operation 503: Obtain win rate data that is generated when the virtual character corresponding to the first account participates in the virtual match.

Obtain win rate data that is generated when the computer device logged into with the first account controls the virtual character to participate in the virtual match. The computer device may be implemented as a terminal device logged into with the first account.

In some embodiments, the win rate data is determined based on a proportion between a quantity of winnings obtained by the virtual character corresponding to the first account when participating in the virtual match and a total quantity of virtual matches in which the virtual character corresponding to the first account participates.

In some embodiments, the total quantity of virtual matches in which the virtual character corresponding to the first account participates includes: a virtual match in which the virtual character corresponding to the first account participates and obtains a match result, and a virtual match in which the virtual character corresponding to the first account participates but does not obtain a match result and gives up.

In some embodiments, the win rate data that is generated when the virtual character corresponding to the first account participates in the virtual match may be obtained under a condition. For example, obtaining win rate data that is generated after the first virtual character corresponding to the first account participates in the virtual match, that is, a proportion between a quantity of winnings obtained by the first virtual character corresponding to the first account when participating in the virtual match and a total quantity of virtual matches in which the first virtual character corresponding to the first account participates; or obtaining win rate data that is generated after the virtual character corresponding to the first account participates in the virtual match at the first lane position, that is, a proportion between a quantity of winnings obtained by the virtual character corresponding to the first account when participating in the virtual match at the first lane position and a total quantity of virtual matches in which the virtual character corresponding to the first account participates at the first lane position; or obtaining win rate data that is generated after the first virtual character corresponding to the first account participates in the virtual match at the first lane position. The obtaining condition is not limited in this embodiment of this application.

In some embodiments, that the virtual character corresponding to the first account participates in and wins the virtual match includes at least one of the following cases:
1. The virtual character corresponding to the first account and virtual characters of other teammates form a team to defeat virtual characters in other teams;
2. The virtual character corresponding to the first account obtains a specified resource element from the virtual match in a team or non-team form;
3. The virtual character corresponding to the first account and virtual characters of other teammates form a team to destroy specified virtual objects corresponding to other team camps; and
4. The first account completes a specified virtual task in the virtual match in a team or non-team form.

The above manners of winning are merely examples, and determination of winning is not limited in this embodiment of this application.

In some embodiments, a time period range for obtaining the first character data is the same as that for obtaining the win rate data. To avoid increasing data pressure on the server, and to avoid impact of different character performance on character scoring data due to updating of character skills or parameters between different season time periods, a season time period corresponding to the current moment is obtained, where the season time period is a time period obtained through division in advance, and the first character data that is generated after the virtual character corresponding to the first account participates in the virtual match within the season time period is obtained, that is, the first character data that is generated after the computer device logged into with the first account controls the virtual character to participate in the virtual match within the season time period is obtained. In addition, win rate data that is generated when the virtual character corresponding to the first account participates in the virtual match within the season time period is obtained, that is, win rate data that is generated when the computer device logged into with the first account controls the virtual character to participate in the virtual match within the season time period is obtained.

In the foregoing embodiment, the first character data and the win rate data are obtained based on the season time period. On the one hand, avoid occupation of computing resources for obtaining full data. On the other hand, avoid a problem of relatively low data accuracy due to differences in character configurations between different seasons that exist after data in other season time periods is obtained.

In some embodiments, when a time difference between a start moment of the season time period and the current moment is greater than a preset duration threshold, the first character data that is generated within a first time period after the computer device logged into with the first account controls the virtual character to participate in the virtual match is determined, the first time period being a time range with the current moment as an end moment and the preset duration threshold as duration. In addition, win rate data that is generated when the virtual character corresponding to the first account participates in the virtual match within the first time period is obtained. For example, when the preset duration threshold is 30 days, first character data and win rate data within first 30 days are obtained by using the current moment as an end day.

In the foregoing embodiment, when the time difference between the start moment of the season time period and the current moment exceeds the preset duration threshold, only data within the preset duration threshold range is obtained, thereby further avoiding a problem of occupation of computing resources caused by a large data volume.

Operation 504: Generate character comprehensive scoring data based on the sorting data and the win rate data.

The character comprehensive scoring data is configured for displaying on an interface of a terminal logged into with the first account. That is, the character comprehensive scoring data is configured for displaying on an interface of the computer device logged into with the first account. For example, a MOBA game is installed and run in the terminal, the first account is logged into the MOBA game, and the character comprehensive scoring data is presented on a data presentation interface of the MOBA game.

In some embodiments, the generating character comprehensive scoring data based on the sorting data and the win rate data includes at least one of the following manners.

Manner 1: Perform weighted summation on the sorting data and the win rate data, to obtain the character comprehensive scoring data.

For example, a first weight corresponding to the sorting data is obtained, and a second weight corresponding to the win rate data is obtained. Weighted summation is performed on the sorting data and the win rate data based on the first weight and the second weight, to obtain the character comprehensive scoring data.

The first weight and the second weight are preset.

Alternatively, the first weight and the second weight are determined based on the quantity of virtual matches in which the virtual object corresponding to the first account participates. For example, when the quantity of virtual matches in which the virtual object corresponding to the first account participates is less than a quantity threshold, the first weight is greater than the second weight. For example, the first weight is determined to be 0.7, and the second weight is determined to be 0.3. Because the quantity of virtual matches in which the virtual object corresponding to the first account participates is relatively small, and accuracy of a capability of the first account expressed by the win rate data is relatively low, while accuracy of the capability of the first account expressed by the sorting data generated based on character performance in the virtual match is relatively high, the first weight of the sorting data is set to a value higher than the second weight, thereby improving accuracy of the character comprehensive scoring data. When the quantity of virtual matches in which the virtual object corresponding to the first account participates reaches the quantity threshold, the first weight is less than the second weight. For example, the first weight is determined to be 0.3, and the second weight is determined to be 0.7. Because the quantity of virtual matches in which the virtual object corresponding to the first account participates is relatively large, that is, the win rate data expresses a comprehensive win situation of the first account in a plurality of virtual matches, the accuracy of the capability of the first account expressed by the win rate data is relatively high, while the sorting data that is generated based on character performance in the virtual match tends to be an average value with a relatively small variation, and has relatively low accuracy of expressing the capability of the first account, the first weight of the sorting data is set to a value lower than the second weight, thereby improving accuracy of the character comprehensive scoring data.

In the foregoing example, two segments, in which the quantity of participating in the match is less than or reaches the quantity threshold, are used as an example for description. In some embodiments, a quantity of segments may be more. For example, when the quantity of virtual matches in which the virtual object corresponding to the first account participates is within a first quantity interval, a weight value of the first weight is greater than a first value of the second weight; when the quantity of virtual matches in which the virtual object corresponding to the first account participates is within a second quantity interval, the weight value of the first weight and a weight value of the second weight are the same; and when the quantity of virtual matches in which the virtual object corresponding to the first account participates is within a third quantity interval, the weight value of the second weight is greater than a second value of the first weight. A value within the first quantity interval is less than a value within the second quantity interval; and a value within the second quantity interval is less than a value within the third quantity interval.

In the foregoing method, the sorting data and the win rate data are calculated by setting different weights, and adaptability is considered for the sorting data and the win rate data, thereby improving accuracy of the character comprehensive scoring data. In addition, for different quantities of virtual matches in which the virtual object corresponding to the first account participates, different weight values are designed. Impact of different quantities of participating in the virtual match to accuracy of the sorting data and the win rate data is considered, thereby further improving accuracy of the character comprehensive scoring data.

Manner 2: To prevent the character comprehensive scoring data from being excessively dispersed, restrict the character comprehensive scoring data by using the preset value range.

For example, a first difference is obtained based on the sorting data and a first reference value, a second difference is obtained based on the win rate data and a second reference value, and a sum of the first difference, the second difference, and a third reference value is used as candidate comprehensive scoring data. The candidate comprehensive scoring data is determined as the character comprehensive scoring data in response to a case in which the candidate comprehensive scoring data is within a preset value range; and in response to a case in which the candidate comprehensive scoring data exceeds the preset value range, endpoint data that has a small difference with the candidate comprehensive scoring data and that is within the preset value range is used as the character comprehensive scoring data.

For example, a calculation manner of the character comprehensive scoring data is shown in the following formula 1:

$$Formula 1$$

$$W = MIN [ 150 , MAX [ 70 , ( X - 40 \% ) \times 100 + 60 + ( Y - 50 \% ) \times 100 ] ] ,$$

W represents the character comprehensive scoring data, X represents the sorting data that is generated when the virtual character corresponding to the first account participates in the virtual match, and Y represents the win rate data that is generated when the virtual character corresponding to the first account participates in the virtual match. The character comprehensive scoring data calculated by using formula 1 is within a preset value range of 70 to 150.

The above manners of calculating the character comprehensive scoring data are merely examples, and the manner of calculating the character comprehensive scoring data is not limited in this embodiment of this application.

In the foregoing method, the character comprehensive scoring data is restricted by using the preset value range, the sorting data is evaluated by using the first reference value, and the win rate data is evaluated by using the second reference value, thereby improving an accuracy rate of obtaining the character comprehensive scoring data.

In conclusion, in this embodiment of this application, when match performance of the player is scored, the comprehensive score of the player is determined based on the win rate data of the player to participate in the virtual match and a ranking relationship between the match data that is generated when the player participates in the virtual match and other players. On the one hand, the match performance of the player is comprehensively evaluated based on the comprehensive score. The comprehensive score can not only reflect a win rate of the player, but also reflect specific performance data of the player in the match, thereby improving comprehensiveness of evaluation on the match performance of the player. On the other hand, the ranking relationship between the match data that is generated when the player participates in the virtual match and other players is introduced, so that the comprehensive score can reflect a match level of the player compared with an entire player group, thereby improving accuracy of evaluation on the match performance of the player.

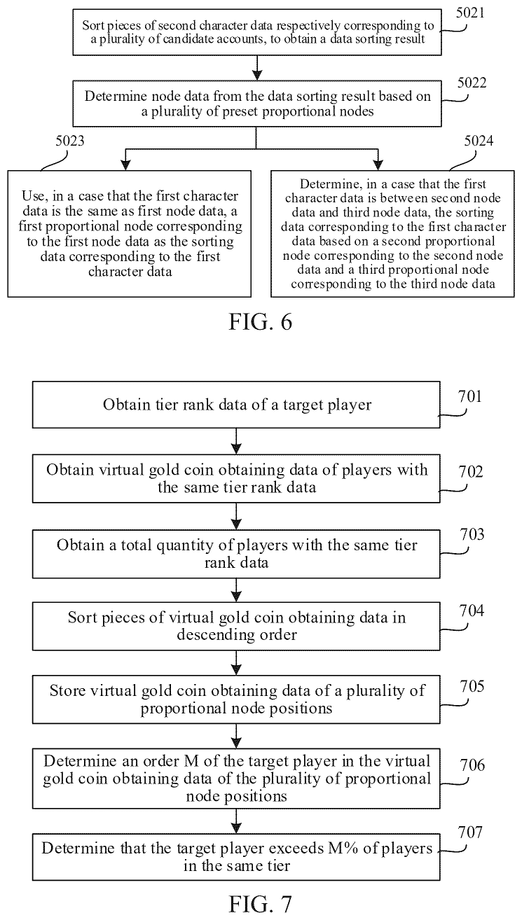

In an exemplary embodiment, for a value relationship between the first character data and the node data, the sorting data corresponding to the first character data is determined. FIG. 6 is a flowchart of a scoring method based on a virtual match according to another exemplary embodiment of this application. An example in which the method is applied to a server is used for description. As shown in FIG. 6, the foregoing operation 502 includes at least the following operation 5021 to operation 5024.

Operation 5021: Sort pieces of second character data respectively corresponding to a plurality of candidate accounts, to obtain a data sorting result.

The plurality of candidate accounts match the tier rank data when the second character data is generated. In some embodiments, the plurality of candidate accounts are all accounts matching the tier rank data when the second character data is generated.

In some embodiments, the pieces of second character data of the plurality of candidate accounts are sorted in descending order of values, or the pieces of second character data of the plurality of candidate accounts are sorted in ascending order of values.

In some embodiments, when pieces of character data with the same value exist in the pieces of second character data of the plurality of candidate accounts, at least one of the following processing manners is included: 1. The pieces of character data with the same value are reserved for sorting. For example, when resource obtaining data of three accounts is 100 gold coins, the pieces of resource obtaining data of the three accounts are sorted in a data sorting result based on a preset order or a random order. For example, when resource obtaining data of account 1, account 2, and account 3 are all 100 gold coins, account 1, account 2, and account 3 are sorted based on a preset order (for example, a sequence of account identifier size) or a random order. 2. Any one of pieces of character data with the same value is reserved for sorting. For example, when there are three accounts with resource obtaining data of 100 gold coins, the resource obtaining data of 100 gold coins of one account is sorted in a data sorting result.

The character data corresponds to data generated in a single virtual match of a single account, or the character data corresponds to average data generated in a plurality of virtual matches of a single account.

In some embodiments, when the pieces of second character data of the plurality of candidate accounts are sorted, a specified proportion of data is randomly deleted from the second character data of the plurality of candidate accounts. For example, when the specified proportion is 30%, 30% of character data is randomly deleted from the second character data of the plurality of candidate accounts, thereby reducing an amount of character data participating in sorting, improving sorting efficiency, and reducing a resource calculation amount and data processing pressure during data sorting.

Operation 5022: Determine node data from the data sorting result based on a plurality of preset proportional nodes.

The node data is data at sorting positions respectively corresponding to the plurality of proportional nodes in the data sorting result.

In some embodiments, to reduce a data storage amount, proportional nodes obtained after the comprehensive character data is sorted are stored, to avoid storing all the comprehensive character data, and only data of the proportional nodes needs to be stored. The node data is determined from the data sorting result based on the plurality of preset proportional nodes. The node data is data with sorting positions respectively corresponding to the plurality of proportional nodes in the data sorting result.

An example in which 1% is a node change gradient is used, and node data corresponding to 100%, 99%, . . . , 2%, and 1% proportional nodes is stored. The node data of the 100% proportional nodes is largest character data in all character data, the node data of the 99% proportional nodes is character data that exceeds 99% other character data, and so on.

After the plurality of pieces of node data is determined, the sorting data corresponding to the first character data may be determined based on a matching relationship between the first character data and a plurality of pieces of node data.

Operation 5023: Use, when the first character data is the same as first node data, a first proportional node corresponding to the first node data as the sorting data corresponding to the first character data.

In some embodiments, when the first character data is the same as the first node data corresponding to the first proportional node in the plurality of proportional nodes, it indicates that a ranking of the first character data in the comprehensive character data is the same as that of the first node data, and the ranking corresponding to the first node data is an order represented by the first proportional node. Therefore, the first proportional node is used as the sorting data corresponding to the first character data.

In the foregoing embodiment, the first character data is matched with the plurality of pieces of node data, and when the first character data is the same as the first node data, the first proportional node corresponding to the first node data is directly used as the sorting data of the first character data, thereby improving efficiency of determining the sorting data, and reducing a calculation amount in a process of determining the sorting data.

Operation 5024: Determine, when the first character data is between second node data and third node data, the sorting data corresponding to the first character data based on a second proportional node corresponding to the second node data and a third proportional node corresponding to the third node data.

When the first character data is between the second node data and the third node data, it indicates that the first character data is within a data range constructed by the second node data and the third node data. The second proportional node corresponding to the second node data and the third proportional node corresponding to the third node data are two adjacent proportional nodes in the plurality of proportional nodes. That is, the first character data is sorted between the second proportional node and the third proportional node.

The determining the sorting data corresponding to the first character data based on a second proportional node and a third proportional node includes at least one of the following manners.

Manner 1: Determine, when the first character data is between the second node data and the third node data, and a first difference between the first character data and the second node data is less than a second difference between the first character data and the third node data, the second proportional node corresponding to the second node data as the sorting data corresponding to the first character data.

That is, a target data node that is in the second node data and the third node data and that has a smaller data difference with the first character data is determined, and a proportional node corresponding to the target data node is used as the sorting data corresponding to the first character data. For example, when a data difference between the second node data and the first character data is 50, a second proportional node corresponding to the second node data is 71%, a data difference between the third node data and the first character data is 40, and a third proportional node corresponding to the third node data is 72%, the second proportional node 71% corresponding to the second node data is used as the sorting data corresponding to the first character data.

When the data difference between the first character data and the second node data is equal to the data difference between the third node data and the first character data, a node intermediate value of the second proportional node and the third proportional node is determined as the sorting data corresponding to the first character data. For example, when the data difference between the second node data and the first character data is 50, the second proportional node corresponding to the second node data is 71%, the data difference between the third node data and the first character data is 50, and the third proportional node corresponding to the third node data is 72%, the second proportional node 71.5% corresponding to the second node data is used as the sorting data corresponding to the first character data.

In the foregoing method, node data closer to the first character data is determined from the second node data and the third node data based on the first difference between the first character data and the second node data and the second difference between the first character data and the third node data, and a corresponding proportional node is determined as the sorting data corresponding to the first character data, thereby improving efficiency of determining the sorting data.

Manner 2: Determine, between the second proportional node and the third proportional node when the first character data is between the second node data and the third node data, a sorting proportion corresponding to the first character data as the sorting data based on the first difference between the first character data and the second node data and the second difference between the first character data and the third node data.

That is, the data difference between the second node data and the first character data and the data difference between the third node data and the first character data are determined respectively, and the sorting proportion of the first character data is determined between the second proportional node and the third proportional node based on an allocation proportion of the data difference. For example, when the data difference between the second node data and the first character data is 40, the second proportional node corresponding to the second node data is 71%, the data difference between the third node data and the first character data is 60, and the third proportional node corresponding to the third node data is 72%, 71.4% is determined, based on percentages respectively corresponding to 40 and 60, between the second proportional node 71% and the third proportional node 72% as the sorting data corresponding to the first character data.

In the foregoing method, based on the first difference between the first character data and the second node data and the second difference between the first character data and the third node data, the sorting proportion is determined in the second proportional node and the third proportional node as the sorting data, thereby improving expression accuracy of the sorting data.

In some embodiments, when the sorting proportion corresponding to the first character data is determined based on the first difference and the second difference, percentage data of the sorting proportion is rounded to one decimal place.

An example in which the character data is implemented as virtual gold coins obtained by a specified virtual character corresponding to an account in a virtual match is used for description. As shown in FIG. 7, a process of obtaining the sorting data corresponding to the first character data is shown in a flowchart of FIG. 7, and includes the following operations.

Operation 701: Obtain tier rank data of a target player.

The tier rank data represents a level of the first account achieved by obtaining points after participating in the virtual match. In some embodiments, an account participating in the virtual match has corresponding tier rank data; or an account participating in a virtual match of a specified type has corresponding tier rank data.

Operation 702: Obtain virtual gold coin obtaining data of players with the same tier rank data.

That is, after tier rank data of all players is obtained, virtual gold coin obtaining data corresponding to another player with the same tier rank data as the target player is determined.

Operation 703: Obtain a total quantity of players with the same tier rank data.

After the tier rank data of all players is obtained, the total quantity of players with the same tier rank data as the target player is determined.

Operation 704: Sort pieces of virtual gold coin obtaining data in descending order.

Pieces of virtual gold coin obtaining data respectively corresponding to the players with the same tier rank data are sorted in descending order.

Operation 705: Store virtual gold coin obtaining data of a plurality of proportional node positions.

Based on a plurality of predetermined proportional nodes, virtual gold coin obtaining data corresponding to each proportional node is obtained from pieces of virtual gold coin obtaining data of a plurality of players sorted in sequence. For example, virtual gold coin obtaining data corresponding to a proportional node of 50% indicates that the data exceeds 50% other virtual gold coin obtaining data.

Operation 706: Determine an order M of the target player in the virtual gold coin obtaining data of the plurality of proportional node positions.

A matching relationship of the virtual gold coin obtaining data of the target player in the pieces of virtual gold coin obtaining data corresponding to the plurality of proportional nodes is determined. That is, a proportional node that is in the virtual gold coin obtaining data corresponding to the plurality of proportional nodes and that is closest to the virtual gold coin obtaining data of the target player is determined.

Operation 707: Determine that the target player exceeds M % of players in the same tier.

In conclusion, in this embodiment of this application, the pieces of second character data of the candidate accounts are sorted, and the node data matching the proportional node is determined from the data sorting result based on the proportional node. When the sorting data corresponding to the first character data is determined subsequently, the first character data is compared with the node data matching the plurality of proportional nodes, to determine the sorting data corresponding to the first character data, thereby reducing a calculation amount of data storage and comparison, and improving efficiency of determining the sorting data.

In some embodiments, the character data and the win rate data are selectively obtained based on a sorting requirement. The sorting requirement includes at least one of character-based sorting and lane position-based sorting.

FIG. 8 is a flowchart of a scoring method based on a virtual match according to another exemplary embodiment of this application. An example in which the method is applied to a server is used for description. As shown in FIG. 8, the method includes the following operations.

Operation 8011: Obtain first character data that is generated after a first virtual character corresponding to a first account participates in a virtual match, and obtain tier rank data of the first account.

Obtain the first character data that is generated after a computer device logged into with the first account controls the first virtual character to participate in the virtual match.

The tier rank data represents a level of the first account achieved by obtaining points after participating in the virtual match.

To be specific, the first character data that is generated after the first virtual character corresponding to the first account participates in the virtual match and second character data that is generated after a first virtual character corresponding to a reference account participates in the virtual match are obtained, to evaluate a capability of the first account to control the first virtual character, and the first account is compared in parallel with the reference account, thereby improving accuracy of comparison.

In some embodiments, selection of the first virtual character includes at least one of the following manners: 1. The first virtual character is a virtual character having highest character data used by the first account in a historical time period; 2. The first virtual character is a random virtual character used by the first account in a historical time period; and 3. The first virtual character is a virtual character specified in a scoring data obtaining process.

Operation 8012: Obtain first character data that is generated after the virtual character corresponding to the first account participates in the virtual match at a first lane position, and obtain tier rank data of the first account.

The virtual match includes a plurality of lane positions, the plurality of lane positions indicate strategies for participating in the virtual match, and the plurality of lane positions include a first lane position. The first character data that is generated after the computer device logged into with the first account controls the virtual character to participate in the virtual match at the first lane position is obtained.

To be specific, the first character data that is generated after the virtual character corresponding to the first account participates in the virtual match at the first lane position and the second character data that is generated after the virtual character corresponding to the reference account participates in the virtual match at the first lane position are obtained, to evaluate a capability of the first account to participate in the virtual match at the first lane position, and the first account is compared in parallel with the reference account, thereby improving accuracy of comparison.

In some embodiments, selection of the first lane position includes at least one of the following manners: 1. The first lane position is a lane position at which a virtual character used by the first account in a historical time period obtains highest character data after engaging in a virtual battle; 2. The first lane position is a random lane position; and 3. The first lane position is a lane position specified in a scoring data obtaining process.

Operation 802: Determine sorting data of the first character data in comprehensive character data.

Data types of the first character data and the second character data are the same.

The sorting data is expressed in a form of a sorting proportion. For example, the sorting data represents a proportion by which the first character data exceeds other character data in the comprehensive character data.

In some embodiments, at a data preparation stage before the sorting data is obtained, pieces of second character data of a plurality of candidate accounts are sorted, to obtain a data sorting result. The plurality of candidate accounts are accounts matching the tier rank data when the second character data is obtained.

The sorting data is configured for expressing a sorting order of the first character data in the comprehensive character data.

In some embodiments, the sorting data is expressed in a form of a sorting proportion. For example, the sorting data represents a proportion that the first character data exceeds other character data in the comprehensive character data, for example, exceeds 50% of character data. That is, a sorting position of the first character data in the comprehensive character data is a middle position. Alternatively, the sorting data represents a proportion that the first character data falls below other character data in the comprehensive character data, for example, falls below 50% of character data. That is, a sorting position of the first character data in the comprehensive character data is a middle position, but the sorting position of the first character data is determined in an ascending comparison manner.

In some embodiments, to reduce a data storage amount, proportional nodes obtained after the comprehensive character data is sorted are stored, to avoid storing all the comprehensive character data, and only data of the proportional nodes needs to be stored.

Operation 8031: Obtain win rate data that is generated when the first virtual character corresponding to the first account participates in the virtual match.

Obtain win rate data that is generated when the computer device logged into with the first account controls the first virtual character to participate in the virtual match.

In some embodiments, the win rate data is determined based on a proportion between a quantity of winnings obtained by the first virtual character corresponding to the first account when participating in the virtual match and a total quantity of virtual matches in which the first virtual character corresponding to the first account participates.

Operation 8032: Obtain win rate data that is generated when the virtual character corresponding to the first account participates in the virtual match at the first lane position.

Obtain the win rate data that is generated when the computer device logged into with the first account controls the virtual character to participate in the virtual match at the first lane position.

In some embodiments, the win rate data is determined based on a proportion between a quantity of winnings obtained by the virtual character corresponding to the first account when participating in the virtual match at the first lane position and a total quantity of virtual matches in which the virtual character corresponding to the first account participates at the first lane position.

In the foregoing embodiment, the capability of the first virtual character corresponding to the first account to participate in the virtual match and the capability of the virtual object corresponding to the first account to participate in the virtual match at the first lane position are used as examples for description. In this embodiment of this application, different data obtaining conditions may be set to determine a capability of the first virtual character corresponding to the first account to participate in the virtual match at the first lane position.

Operation 804: Generate character comprehensive scoring data based on the sorting data and the win rate data.

In a case that the first character data that is generated after the first virtual character corresponding to the first account participates in the virtual match is obtained, the comprehensive scoring data is configured for evaluating a capability of the first virtual character corresponding to the first account to participate in the virtual match, and the character comprehensive scoring data is configured for evaluating a capability of the computer device logged into with the first account to control the first virtual character to participate in the virtual match. In a case that the first character data that is generated after the virtual character corresponding to the first account participates in the virtual match at the first lane position is obtained, the character comprehensive scoring data is configured for evaluating a capability of the first account to participate in the virtual match at the first lane position.

The character comprehensive scoring data is configured for displaying on an interface of a terminal logged into with the first account.

In some embodiments, a first difference is obtained based on the sorting data and a first reference value, a second difference is obtained based on the win rate data and a second reference value, and a sum of the first difference, the second difference, and a third reference value is used as candidate comprehensive scoring data. The candidate comprehensive scoring data is determined as the character comprehensive scoring data in response to a case in which the candidate comprehensive scoring data is within a preset value range; and in response to a case in which the candidate comprehensive scoring data exceeds the preset value range, endpoint data that has a small difference with the candidate comprehensive scoring data and that is within the preset value range is used as the character comprehensive scoring data.

In the foregoing embodiment, on the one hand, the first character data that is generated after the first account controls the first virtual character to participate in the virtual match and the second character data that is generated after the reference account controls the first virtual character to participate in the virtual match are obtained, to evaluate the capability of the first account to control the first virtual character, and the first account is compared in parallel with the reference account, thereby improving accuracy of match capability comparison from the perspective of character control. On the other hand, the first character data that is generated after the first account controls the virtual character to participate in the virtual match at the first lane position and the second character data that is generated after the reference account controls the virtual character to participate in the virtual match at the first lane position are obtained, to evaluate the capability of the first account to participate in the virtual match at the first lane position, and the first account is compared in parallel with the reference account, thereby improving accuracy of match capability comparison from the perspective of lane strategy.

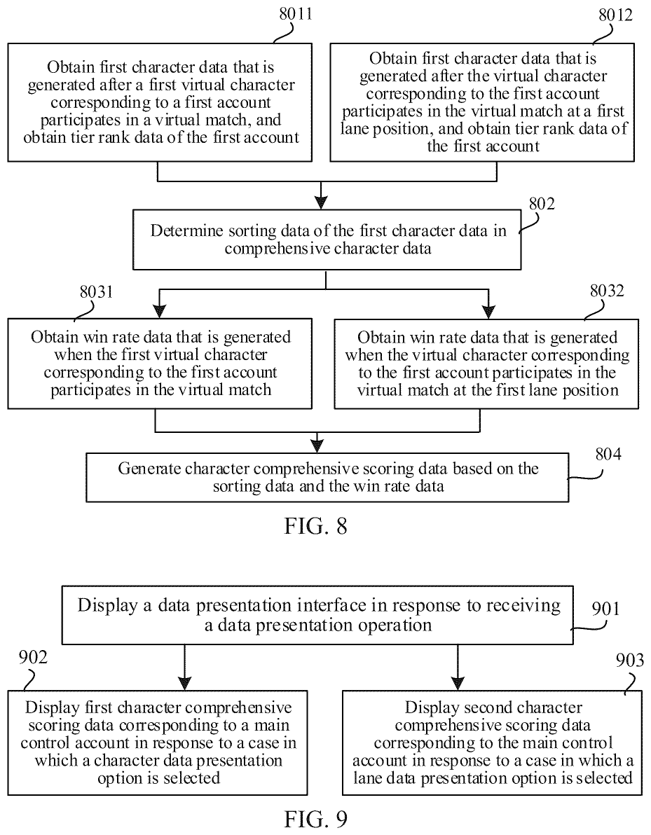

FIG. 9 is a flowchart of a score display method based on a virtual match according to an exemplary embodiment of this application. As shown in FIG. 9, the method is performed by a computer device. The computer device may be a terminal, such as a first device or a second device. The method includes the following operations.

Operation 901: Display a data presentation interface in response to receiving a data presentation operation.

The data presentation interface includes a character data presentation option and a lane data presentation option, the character data presentation option is configured for presenting data that is generated after a virtual character controlled by a main control account engages in a virtual battle and that corresponds to the virtual character, and the lane data presentation option is configured for presenting data that is generated after the main control account engages in the virtual battle by using a first lane as a match role. In some embodiments, the character data presentation option is configured for presenting data that is generated after the computer device logged into with the main control account controls the virtual character to engage in the virtual battle and that corresponds to the virtual character.

Operation 902: Display first character comprehensive scoring data corresponding to the main control account in response to a case in which the character data presentation option is selected.

The first character comprehensive scoring data is determined based on first sorting data and first win rate data, the first sorting data is sorting data corresponding to character data that is generated when a specified virtual character corresponding to the main control account participates in a virtual match, and the first win rate data is win rate data that is generated when the specified virtual character corresponding to the main control account participates in the virtual match.

In some embodiments, the first sorting data is sorting data corresponding to character data that is generated when the computer device logged into with the main control account controls a specified virtual character to participate in a virtual match, and the first win rate data is win rate data that is generated when the computer device logged into with the main control account controls the specified virtual character to participate in the virtual match.

The sorting data is configured for expressing a sorting order of the first character data in the comprehensive character data. In some embodiments, the sorting data is expressed in a form of a sorting proportion. For example, the sorting data represents a proportion that the first character data exceeds other character data in the comprehensive character data, for example, exceeds 50% of character data. That is, a sorting position of the first character data in the comprehensive character data is a middle position. Alternatively, the sorting data represents a proportion that the first character data falls below other character data in the comprehensive character data, for example, falls below 50% of character data. That is, a sorting position of the first character data in the comprehensive character data is a middle position, but the sorting position of the first character data is determined in an ascending comparison manner.

In some embodiments, when the first character comprehensive scoring data corresponding to the main control account is displayed, average data of character data in the same tier and data of the player are further displayed, and a difference between the average data in the same tier and the data of the player is displayed.

In some embodiments, the user may select a virtual character on the data presentation interface, and first character comprehensive scoring data corresponding to the virtual character is presented. In some embodiments, the data presentation interface displays, by default, first character comprehensive scoring data corresponding to the specified virtual character. The specified virtual character is a virtual character with highest first character comprehensive scoring data, or the specified virtual character is a virtual character used by the user for a virtual battle last time, or the specified virtual character is a virtual character customized by the user, or the like. This is not limited herein.

In some embodiments, when receiving a data presentation operation, the terminal loads and displays a data presentation interface. The data presentation interface displays, by default, the first character comprehensive scoring data corresponding to the character data presentation option.

Operation 903: Display second character comprehensive scoring data corresponding to the main control account in response to a case in which the lane data presentation option is selected.

The second character comprehensive scoring data is determined based on second sorting data and second win rate data, the second sorting data is sorting data corresponding to character data that is generated when the virtual character corresponding to the main control account participates in the virtual match at the first lane position, and the second win rate data is win rate data that is generated when the virtual character corresponding to the main control account participates in the virtual match at the first lane position.

In some embodiments, the second sorting data is sorting data corresponding to character data that is generated when the computer device logged into with the main control account controls the virtual character to participate in the virtual match at the first lane position, and the second win rate data is win rate data that is generated when the computer device logged into with the main control account controls the virtual character to participate in the virtual match at the first lane position. The sorting data is configured for expressing a sorting order of the second character data in the comprehensive character data.

In some embodiments, the user may select a lane position on the data presentation interface, and first character comprehensive scoring data corresponding to the lane position is presented. In some embodiments, the data presentation interface displays, by default, first character comprehensive scoring data corresponding to a specified lane position. The specified lane position is a lane position with highest first character comprehensive scoring data, or the specified lane position is a lane position used by the user for a virtual battle last time, or the specified lane position is a lane position customized by the user, or the like. This is not limited herein.

In some embodiments, when receiving a data presentation operation, the terminal loads and displays a data presentation interface. The data presentation interface displays, by default, the second character comprehensive scoring data corresponding to the lane data presentation option.

In conclusion, in this embodiment of this application, when match performance of the player is scored, the comprehensive score of the player is determined based on the win rate data of the player to participate in the virtual match and a ranking relationship between the match data that is generated when the player participates in the virtual match and other players, so that the comprehensive score is presented. The win rate and the match performance of the player are comprehensively evaluated based on the comprehensive score, thereby improving accuracy of evaluation on the match performance of the player, and improving data presentation efficiency when the scoring data is displayed. In addition, the character option and the lane option are disassembled and displayed, the character option reflects the comprehensive score of the player to control the specified virtual character to participate in the virtual match, and the lane option reflects the comprehensive score of the player to participate in the virtual match at the specified lane position, thereby providing multi-dimensional scoring feedback for the player. Such scoring feedback not only covers performance of the player in all matches, but also extends into specific character use and lane strategy layers, and improves feedback accuracy and an information amount when the scoring feedback is provided for the player.

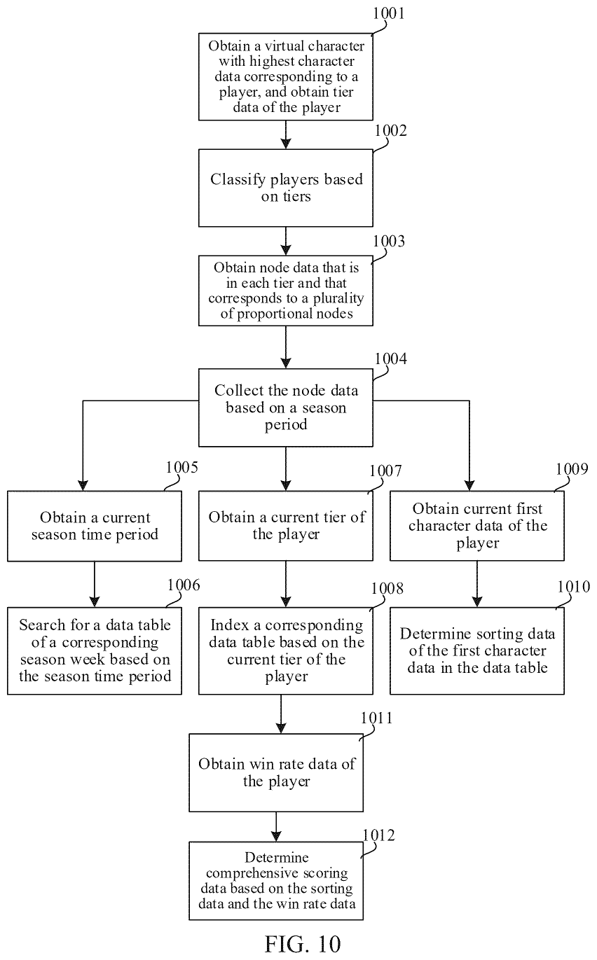

FIG. 10 is a schematic diagram of an overall flow of a scoring method based on a virtual match according to an exemplary embodiment of this application. As shown in FIG. 10, the method includes the following operations.

Operation 1001: Obtain a virtual character with highest character data corresponding to a player, and obtain tier data of the player.

That is, the virtual character controlled by the player when the character data is the highest in virtual matches within a historical time period is obtained.

The tier data represents a tier rank achieved by obtaining points after the player controls the virtual character to participate in the match.

Operation 1002: Classify players based on tiers.

That is, players in different tier ranges are classified to obtain a plurality of tier sets, where each tier set includes players in the same tier range. For example, players in Silver tier are classified into one set; or Silver tier is further divided into Silver rank 1, Silver rank 2, and Silver rank 3, and players in Silver rank 1 are classified into one set.

Operation 1003: Obtain node data that is in each tier and that corresponds to a plurality of proportional nodes.

For players in the same tier set, pieces of character data that are generated after the players in the tier set participate in the virtual match are obtained and sorted, and node data corresponding to each proportional node is obtained based on the sorted character data. A manner of obtaining the node data is described in detail in the foregoing embodiment, and details are not described herein again.

Operation 1004: Collect the node data based on a season period.

To be specific, a value of the node data is updated in real time based on the season period, so that in different seasons, data of the player is matched with the node data in the season, thereby determining sorting data corresponding to the character data of the player.

Character comprehensive scoring data of the player is determined in the following operations.

Operation 1005: Obtain a current season time period.

That is, a season time period of a current moment is determined.

Operation 1006: Search for a data table of a corresponding season week based on the season time period.

In some embodiments, a data table of the node data is updated in a weekly time period.

Operation 1007: Obtain a current tier of the player.

When a score obtaining request of the player is received, the current tier of the player is obtained.

Operation 1008: Index a corresponding data table based on the current tier of the player.

That is, the data table matching the tier is obtained based on the current tier of the player. The data table includes a plurality of reference accounts as second character data of the node data, where the reference accounts match the current tier of the player when the second character data is generated.

Operation 1009: Obtain current first character data of the player.

The first character data is data generated in a latest virtual match of the player, or average data generated in virtual matches in which the player participates in a historical time period. In some embodiments, first character data that is generated when the player controls a first virtual character to participate in the virtual match is obtained; or first character data that is generated when the player controls the virtual character to participate in the virtual match at a first lane position is obtained; or first character data that is generated when the player controls the first virtual character to participate in the virtual match at the first lane position is obtained.

In some embodiments, based on an obtaining condition of the first character data, the data table satisfies the same condition when being obtained. For example, when the first character data is data that is generated when the player controls the first virtual character to participate in the virtual match, the second character data in the data table is data that is generated when a reference account controls the first virtual character to participate in the virtual match.

Operation 1010: Determine sorting data of the first character data in the data table.

That is, a sorting status of the first character data in the data table is determined. The sorting data is reflected in a form of a sorting proportion.

Operation 1011: Obtain win rate data of the player.

The win rate data represents a win rate that is generated when the player participates in the virtual match in a historical time period.

Operation 1012: Determine comprehensive scoring data based on the sorting data and the win rate data.

In conclusion, in the method provided in this embodiment of this application, a player in a low tier is encouraged, and the character comprehensive score is mainly rated by comparing players in the same tier. The player in the low tier is usually given low evaluation in a comprehensive environment of a game, and therefore has a low expectation. However, in the method provided in this embodiment of this application, this type of players may receive evaluation higher than expected, to generate encouragement and stimulate activity.

In the method provided in this embodiment of this application, a requirement is generated for a player in a high tier. Similarly, the player in the high tier is usually given high evaluation in a comprehensive environment of a game, and therefore has a high expectation. However, the player in the high tier actually needs more targets and requirements rather than encouragement. Therefore, this type of players may receive a requirement in the system, to generate motivation and stimulate activity.

In the method provided in this embodiment of this application, data comparison is more detailed. From various dimensions such as economy earned, damage dealt, control, and damage taken, differences between the player and a player with the same hero in the same tier are provided. This helps the player learn of what needs to be improved, to continuously make progress and growing.

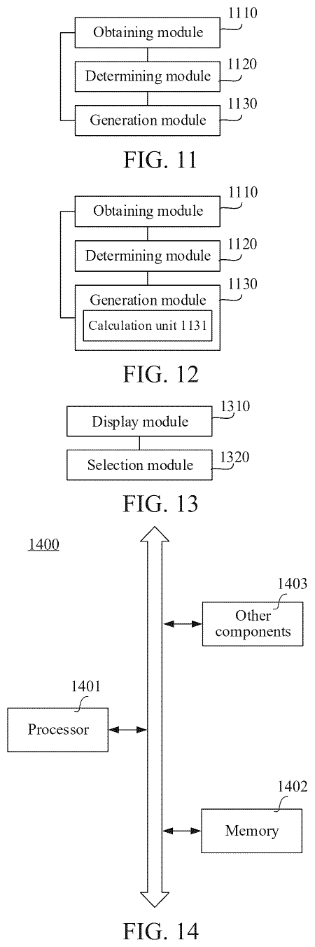

FIG. 11 is a block diagram of a structure of a scoring apparatus based on a virtual match according to an exemplary embodiment of this application. As shown in FIG. 11, the apparatus includes:

an obtaining module 1110, configured to: obtain first character data that is generated after a computer device logged into with a first account controls a virtual character to participate in a virtual match; and obtain tier rank data of the first account, the tier rank data representing a level of the first account achieved by obtaining points after participating in the virtual match;

a determining module 1120, configured to determine sorting data of the first character data in comprehensive character data, the comprehensive character data including a plurality of pieces of second character data, the second character data being data that is generated when a computer device logged into with a reference account controls a virtual character to participate in a virtual match, the reference account matching the tier rank data when the second character data is generated, and a data type of the first character data and a data type of the second character data being the same;
the obtaining module 1110 is further configured to obtain win rate data that is generated when the computer device logged into with the first account controls the virtual character to participate in the virtual match; and a generation module 1130, configured to generate character comprehensive scoring data based on the sorting data and the win rate data, the character comprehensive scoring data being configured for displaying on an interface of the computer device logged into with the first account.

In an exemplary embodiment, the determining module 1120 is further configured to: sort pieces of second character data respectively corresponding to a plurality of candidate accounts, to obtain a data sorting result, the plurality of candidate accounts matching the tier rank data when the second character data is generated; and determine node data from the data sorting result based on a plurality of preset proportional nodes, the node data being data at sorting positions respectively corresponding to the plurality of proportional nodes in the data sorting result; and the determining module 1120 is further configured to determine the sorting data corresponding to the first character data based on a matching relationship between the first character data and a plurality of pieces of node data.

In an exemplary embodiment, the determining module 1120 is further configured to: use, when the first character data is the same as first node data, a first proportional node corresponding to the first node data as the sorting data corresponding to the first character data; and determine, when the first character data is between second node data and third node data, the sorting data corresponding to the first character data based on a second proportional node corresponding to the second node data and a third proportional node corresponding to the third node data.

In an exemplary embodiment, the determining module 1120 is further configured to: determine, when a first difference between the first character data and the second node data is less than a second difference between the first character data and the third node data, the second proportional node as the sorting data corresponding to the first character data; or determine, between the second proportional node and the third proportional node based on a first difference between the first character data and the second node data and a second difference between the first character data and the third node data, a sorting proportion corresponding to the first character data as the sorting data.

In an exemplary embodiment, the obtaining module 1110 is further configured to: obtain the first character data that is generated after the computer device logged into with the first account controls a first virtual character to participate in the virtual match; and obtain the win rate data that is generated when the computer device logged into with the first account controls the first virtual character to participate in the virtual match; and the character comprehensive scoring data being configured for evaluating a capability of the computer device logged into with the first account to control the first virtual character to participate in the virtual match.

In an exemplary embodiment, the virtual match includes a plurality of lane positions, the plurality of lane positions indicate strategies for participating in the virtual match, and the plurality of lane positions include a first lane position;

the obtaining module 1110 is further configured to: obtain the first character data that is generated after the computer device logged into with the first account controls the virtual character to participate in the virtual match at the first lane position; and obtain the win rate data that is generated when the computer device logged into with the first account controls the virtual character to participate in the virtual match at the first lane position; and the character comprehensive scoring data being configured for evaluating a capability of the first account to participate in the virtual match at the first lane position.

In an exemplary embodiment, the obtaining module 1110 is further configured to: obtain a season time period corresponding to a current moment, the season time period being a time period divided in advance; and obtain the first character data that is generated after the computer device logged into with the first account controls the virtual character to participate in the virtual match within the season time period.

In an exemplary embodiment, the obtaining module 1110 is further configured to determine, when a time difference between a start moment of the season time period and the current moment is greater than a preset duration threshold, the first character data that is generated within a first time period after the computer device logged into with the first account controls the virtual character to participate in the virtual match, the first time period being a time range with the current moment as an end moment and the preset duration threshold as duration. In an exemplary embodiment, the obtaining module 1110 is further configured to obtain win rate data that is generated when the computer device logged into with the first account controls the virtual character to participate in the virtual match within the season time period.

In an exemplary embodiment, as shown in FIG. 12, the generation module 1130 includes:
a calculation unit 1131, configured to: obtain a first difference based on the sorting data and a first reference value; obtain a second difference based on the win rate data and a second reference value; and use a sum of the first difference, the second difference, and a third reference value as candidate comprehensive scoring data; and
the calculation unit 1131 is further configured to: obtain a first difference based on the sorting data and a first reference value; obtain a second difference based on the win rate data and a second reference value; use a sum of the first difference, the second difference, and a third reference value as candidate comprehensive scoring data; determine the candidate comprehensive scoring data as the character comprehensive scoring data in response to a case in which the candidate comprehensive scoring data is within a preset value range; and use, in response to a case in which the candidate comprehensive scoring data exceeds the preset value range, endpoint data that has a small difference with the candidate comprehensive scoring data and that is within the preset value range as the character comprehensive scoring data.

In an exemplary embodiment, the obtaining module 1110 is further configured to: obtain a first weight corresponding to the sorting data, and obtain a second weight corresponding to the win rate data, the first weight and the second weight being determined based on a quantity of virtual matches in which a virtual object corresponding to the first account participates; and
the generation module 1130 is further configured to perform weighted summation on the sorting data and the win rate data based on the first weight and the second weight, to obtain the character comprehensive scoring data.

FIG. 13 is a block diagram of a structure of a scoring apparatus based on a virtual match according to another exemplary embodiment of this application. As shown in FIG. 13, the apparatus includes:
a display module 1310, configured to display a data presentation interface in response to receiving a data presentation operation, the data presentation interface including a character data presentation option and a lane data presentation option, the character data presentation option being configured for presenting data that is generated after a computer device logged into with a main control account controls a virtual character to engage in a virtual battle and that corresponds to the virtual character, and the lane data presentation option being configured for presenting data that is generated after the main control account engages in the virtual battle by using a first lane as a match role;
a selection module 1320, configured to select the character data presentation option;
the display module 1310 is further configured to display first character comprehensive scoring data corresponding to the main control account, the first character comprehensive scoring data being determined based on first sorting data and first win rate data, the first sorting data being sorting data corresponding to character data that is generated when the computer device logged into with the main control account controls a specified virtual character to participate in a virtual match, and the first win rate data being win rate data that is generated when the computer device logged into with the main control account controls the specified virtual character to participate in the virtual match;
a selection module 1320, configured to select the lane data presentation option; and
the display module 1310 is further configured to display first character comprehensive scoring data corresponding to the main control account, the first character comprehensive scoring data being determined based on first sorting data and first win rate data, the first sorting data being sorting data corresponding to character data that is generated when the computer device logged into with the main control account controls a specified virtual character to participate in a virtual match, and the first win rate data being win rate data that is generated when the computer device logged into with the main control account controls the specified virtual character to participate in the virtual match.

The scoring apparatus based on a virtual match provided in the foregoing embodiment is illustrated only with an example of division of the foregoing function modules. In practical applications, the foregoing functions may be allocated to and completed by different function modules based on requirements. That is, an internal structure of the device is divided into different function modules to complete all or some of the functions described above. In addition, the scoring apparatus based on a virtual match provided in the foregoing embodiment and the embodiments of the scoring method based on a virtual match belong to the same concept. For a specific implementation process, refer to the method embodiments. Details are not described herein again.

FIG. 14 is a block diagram of a structure of a computer device 1400 according to an exemplary embodiment of this application. The computer device 1400 may be a smartphone, a tablet computer, a moving picture experts group audio layer III (MP3) player, a moving picture experts group audio layer IV (MP4) player, a notebook computer, or a desktop computer. The computer device 1400 may further be referred to as another name such as user equipment, a portable terminal, a laptop terminal, or a desktop terminal.

Generally, the computer device 1400 includes a processor 1401 and a memory 1402.

The processor 1401 may include one or more processing cores, for example, a 4-core processor or an 8-core processor. The processor 1401 may be implemented in at least one hardware form of a digital signal processor (DSP), a field-programmable gate array (FPGA), and a programmable logic array (PLA). The processor 1401 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1401 may be integrated with a graphics processing unit (GPU). The GPU is configured to render and draw content that needs to be displayed on a display screen. In some embodiments, the processor 1401 may further include an AI processor. The AI processor is configured to process a computing operation related to machine learning.

The memory 1402 may include one or more computer-readable storage media. The computer-readable storage medium may be non-transitory. The memory 1402 may further include a high-speed random access memory and a nonvolatile memory, for example, one or more disk storage devices or flash storage devices. In some embodiments, the non-transitory computer-readable storage medium in the memory 1402 is configured to store at least one instruction. The at least one instruction is executed by the processor 1401 to implement the scoring method based on a virtual match provided in the method embodiment of this application.

In some embodiments, the computer device 1400 further includes some other components 1403. Types and a quantity of other components 1403 may be selected based on functions of the computer device 1400. Those skilled in the art may understand that the structure shown in FIG. 14 does not constitute a limitation to the computer device 1400, and the computer device 1400 may include more or fewer components than those shown in the figure, or some components may be combined, or a different component deployment may be used.

In some embodiments, the computer-readable storage medium may include: a read-only memory (ROM), a random access memory (RAM), a solid state drive (SSD), an optical disc, or the like. The random access memory may include a resistance random access memory (ReRAM) and a dynamic random access memory (DRAM). The sequence numbers of the foregoing embodiments of this application are merely for description purpose but do not imply the preference among the embodiments.

An embodiment of this application further provides a computer device. The computer device includes a processor and a memory, the memory having at least one instruction, at least one program, a code set or an instruction set stored therein, the at least one instruction, the at least one program, the code set or the instruction set being loaded and executed by the processor to implement the scoring method based on a virtual match according to any one of the foregoing embodiments of this application.

An embodiment of this application further provides a computer-readable storage medium. The storage medium has at least one instruction, at least one program, a code set or an instruction set stored therein, the at least one instruction, the at least one program, the code set or the instruction set being loaded and executed by a processor to implement the scoring method based on a virtual match according to any one of the foregoing embodiments of this application.

An embodiment of this application further provides a computer program product or a computer program, the computer program product or the computer program includes computer instructions. The computer instructions are stored in a computer-readable storage medium. A processor of a computer device reads the computer instructions from the computer-readable storage medium and executes the computer instructions to cause the computer device to perform the scoring method based on a virtual match according to any one of the foregoing embodiments.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for scoring a virtual match performed by a computer device, the method comprising:
obtaining first character data of a first virtual character after a first account controls the virtual character to participate in a virtual match;
obtaining tier rank data of the first account, the tier rank data representing a level of the first account after participating in the virtual match;
determining sorting data of the first character data in comprehensive character data, the comprehensive character data comprising a plurality of pieces of second character data of a second virtual character after a reference account controls the second virtual character to participate in a virtual match;
obtaining win rate data of the first account that controls the first virtual character to participate in the virtual match;
generating character comprehensive scoring data based on the sorting data and the win rate data; and
displaying the character comprehensive scoring data on an interface of the computer device associated with the first account.

2. The method according to claim 1, wherein the determining sorting data of the first character data in comprehensive character data further comprises:
sorting pieces of second character data respectively corresponding to a plurality of candidate accounts, to obtain a data sorting result, the plurality of candidate accounts matching the tier rank data of the first account;
determining node data from the data sorting result based on a plurality of preset proportional nodes, the node data being data at sorting positions respectively corresponding to the plurality of proportional nodes in the data sorting result; and
determining the sorting data corresponding to the first character data based on a matching relationship between the first character data and a plurality of pieces of node data.

3. The method according to claim 2, wherein the determining the sorting data corresponding to the first character data based on a matching relationship between the first character data and a plurality of pieces of node data comprises:
when the first character data is the same as first node data, using a first proportional node corresponding to the first node data as the sorting data corresponding to the first character data; and
when the first character data is between second node data and third node data, determining the sorting data corresponding to the first character data based on a second proportional node corresponding to the second node data and a third proportional node corresponding to the third node data.

4. The method according to claim 3, wherein the determining the sorting data corresponding to the first character data based on a second proportional node corresponding to the second node data and a third proportional node corresponding to the third node data comprises:
when a first difference between the first character data and the second node data is less than a second difference between the first character data and the third node data, determining the second proportional node as the sorting data corresponding to the first character data; or
determining, between the second proportional node and the third proportional node based on a first difference between the first character data and the second node data and a second difference between the first character data and the third node data, a sorting proportion corresponding to the first character data as the sorting data.

5. The method according to claim 1, wherein the obtaining first character data of the first virtual character after the first account controls the virtual character to participate in the virtual match comprises:
obtaining the first character data that is generated after the computer device logged into with the first account controls a first virtual character to participate in the virtual match.

6. The method according to claim 1, wherein the obtaining win rate data of the first account that controls the first virtual character to participate in the virtual match comprises:
obtaining win rate data of the first account that controls the first virtual character to participate in the virtual match;
the character comprehensive scoring data being configured for evaluating a capability of the computer device logged into with the first account to control the first virtual character to participate in the virtual match.

7. The method according to claim 1, wherein the virtual match comprises a plurality of lane positions, the plurality of lane positions indicate strategies for participating in the virtual match, and the plurality of lane positions comprise a first lane position;
the obtaining first character data of the first virtual character after the first account controls the virtual character to participate in the virtual match comprises:
obtaining the first character data that is generated after the computer device logged into with the first account controls the virtual character to participate in the virtual match at the first lane position.

8. The method according to claim 1, wherein the obtaining win rate data of the first account that controls the first virtual character to participate in the virtual match comprises:
obtaining the win rate data of the first account that controls the first virtual character to participate in the virtual match;
the character comprehensive scoring data being configured for evaluating a capability of the first account to participate in the virtual match at the first lane position.

9. The method according to claim 1, wherein the obtaining first character data of the first virtual character after the first account controls the virtual character to participate in the virtual match comprises:
obtaining a season time period corresponding to a current moment, the season time period being a time period divided in advance; and
obtaining the first character data that is generated after the computer device logged into with the first account controls the virtual character to participate in the virtual match within the season time period.

10. The method according to claim 7, wherein the obtaining the first character data that is generated after the computer device logged into with the first account controls the virtual character to participate in the virtual match within the season time period comprises:
determining, when a time difference between a start moment of the season time period and the current moment is greater than a preset duration threshold, the first character data that is generated within a first time period after the computer device logged into with the first account controls the virtual character to participate in the virtual match, the first time period being a time range with the current moment as an end moment and the preset duration threshold as duration.

11. The method according to claim 1, wherein the obtaining win rate data of the first account that controls the first virtual character to participate in the virtual match comprises:
obtaining win rate data that is generated when the computer device logged into with the first account controls the virtual character to participate in the virtual match within the season time period.

12. The method according to claim 1, wherein the generating character comprehensive scoring data based on the sorting data and the win rate data comprises:
obtaining a first difference based on the sorting data and a first reference value;
obtaining a second difference based on the win rate data and a second reference value;
using a sum of the first difference, the second difference, and a third reference value as candidate comprehensive scoring data;
determining the candidate comprehensive scoring data as the character comprehensive scoring data in response to a case in which the candidate comprehensive scoring data is within a preset value range; and
using, in response to a case in which the candidate comprehensive scoring data exceeds the preset value range, endpoint data that has a small difference with the candidate comprehensive scoring data and that is within the preset value range as the character comprehensive scoring data.

13. The method according to claim 1, wherein the generating character comprehensive scoring data based on the sorting data and the win rate data comprises:
obtaining a first weight corresponding to the sorting data, and obtaining a second weight corresponding to the win rate data, the first weight and the second weight being determined based on a quantity of virtual matches in which a virtual object corresponding to the first account participates; and
performing weighted summation on the sorting data and the win rate data based on the first weight and the second weight, to obtain the character comprehensive scoring data.

14. A computer device, comprising a processor and a memory, the memory having at least one instruction stored therein, and the at least one instruction, when executed by the processor, causing the computer device to implement a scoring method including:
obtaining first character data of a first virtual character after a first account controls the virtual character to participate in a virtual match;
obtaining tier rank data of the first account, the tier rank data representing a level of the first account after participating in the virtual match;
determining sorting data of the first character data in comprehensive character data, the comprehensive character data comprising a plurality of pieces of second character data of a second virtual character after a reference account controls the second virtual character to participate in a virtual match;
obtaining win rate data of the first account that controls the first virtual character to participate in the virtual match;
generating character comprehensive scoring data based on the sorting data and the win rate data; and
displaying the character comprehensive scoring data on an interface of the computer device associated with the first account.

15. The computer device according to claim 14, wherein the determining sorting data of the first character data in comprehensive character data further comprises:
sorting pieces of second character data respectively corresponding to a plurality of candidate accounts, to obtain a data sorting result, the plurality of candidate accounts matching the tier rank data of the first account;
determining node data from the data sorting result based on a plurality of preset proportional nodes, the node data being data at sorting positions respectively corresponding to the plurality of proportional nodes in the data sorting result; and
determining the sorting data corresponding to the first character data based on a matching relationship between the first character data and a plurality of pieces of node data.

16. The computer device according to claim 15, wherein the determining the sorting data corresponding to the first character data based on a matching relationship between the first character data and a plurality of pieces of node data comprises:
when the first character data is the same as first node data, using a first proportional node corresponding to the first node data as the sorting data corresponding to the first character data; and
when the first character data is between second node data and third node data, determining the sorting data corresponding to the first character data based on a second proportional node corresponding to the second node data and a third proportional node corresponding to the third node data.

17. The computer device according to claim 16, wherein the determining the sorting data corresponding to the first character data based on a second proportional node corresponding to the second node data and a third proportional node corresponding to the third node data comprises:
when a first difference between the first character data and the second node data is less than a second difference between the first character data and the third node data, determining the second proportional node as the sorting data corresponding to the first character data; or
determining, between the second proportional node and the third proportional node based on a first difference between the first character data and the second node data and a second difference between the first character data and the third node data, a sorting proportion corresponding to the first character data as the sorting data.

18. A non-transitory computer-readable storage medium, having at least one instruction stored therein, the at least one instruction, when executed by a processor of a computer device, causing the computer device to implement a scoring method based on a virtual match including:
obtaining first character data of a first virtual character after a first account controls the virtual character to participate in a virtual match;
obtaining tier rank data of the first account, the tier rank data representing a level of the first account after participating in the virtual match;
determining sorting data of the first character data in comprehensive character data, the comprehensive character data comprising a plurality of pieces of second character data of a second virtual character after a reference account controls the second virtual character to participate in a virtual match;
obtaining win rate data of the first account that controls the first virtual character to participate in the virtual match;
generating character comprehensive scoring data based on the sorting data and the win rate data; and
displaying the character comprehensive scoring data on an interface of the computer device associated with the first account.

19. The non-transitory computer-readable storage medium according to claim 18, wherein the determining sorting data of the first character data in comprehensive character data further comprises:
sorting pieces of second character data respectively corresponding to a plurality of candidate accounts, to obtain a data sorting result, the plurality of candidate accounts matching the tier rank data of the first account;
determining node data from the data sorting result based on a plurality of preset proportional nodes, the node data being data at sorting positions respectively corresponding to the plurality of proportional nodes in the data sorting result; and
determining the sorting data corresponding to the first character data based on a matching relationship between the first character data and a plurality of pieces of node data.

20. The non-transitory computer-readable storage medium according to claim 18, wherein the determining the sorting data corresponding to the first character data based on a matching relationship between the first character data and a plurality of pieces of node data comprises:
when the first character data is the same as first node data, using a first proportional node corresponding to the first node data as the sorting data corresponding to the first character data; and
when the first character data is between second node data and third node data, determining the sorting data corresponding to the first character data based on a second proportional node corresponding to the second node data and a third proportional node corresponding to the third node data.
